(19) United States
(12) Patent Application Publication
(10) Pub. No.: US 2016/0267600 A1
(43) Pub. Date: Sep. 15, 2016

(54) METHODS AND SYSTEMS FOR INFORMATION TECHNOLOGY (IT) PORTFOLIO TRANSFORMATION

(71) Applicant: Wipro Limited, Bangalore (IN)

(72) Inventors: Guruprasad Kambaloor Nagaraja, Bangalore (IN); Chethan Prabhudeva, Bangalore (IN)

(21) Appl. No.: 14/742,965

(22) Filed: Jun. 18, 2015

(30) Foreign Application Priority Data
Mar. 9, 2015 (IN) 1148/CHE/2015

(51) Int. Cl. G06Q 40/06

(52) U.S. Cl. CPC G06Q 40/06

(57) ABSTRACT

This disclosure relates generally to Information Technology (IT) and more particularly to methods and systems for IT Portfolio Transformation. In one embodiment, a method for transforming a portfolio of assets is disclosed. The method includes capturing, via a processor, an existing state of each of a plurality of objects and interdependencies amongst the plurality of objects based on at least one criterion selected for rationalization of the plurality of objects. The method further includes creating, via the processor, an assessment design to identify a plurality of gaps in the existing state of the plurality of objects. Thereafter, the method includes performing analysis, via the processor, on information collected corresponding to each of the plurality of gaps and employing feedback and machine learning on the analysis performed to generate a transformation roadmap for the portfolio of assets.

This application claims the benefit of Indian Patent Application Serial No. 1148/CHE/2015 filed Mar. 9, 2015, which is hereby incorporated by reference in its entirety.

### TECHNICAL FIELD

This disclosure relates generally to Information Technology (IT) and more particularly to methods and systems for IT portfolio transformation.

### BACKGROUND

Organizations perform transformation by using quantitative and/or qualitative assessment techniques. To achieve this, firstly the existing state of the object that is being assessed within the organization is captured. Examples of the object being assessed include processes, enterprise and business information entity, data and information sources, data center, databases, servers, end user computing device, service desk, messaging, monitoring tools, backup, and storage. The existing state thus captured is then used to perform analysis for generating a roadmap for transformation of the organization.

However, in conventional systems assessments are done in silo, such that, at a given point of time, focus of assessment is on a single object, for example, either only on the applications or only on the infrastructure. These assessments are then later merged to provide recommendation for transformation. Thus, the conventional systems fail to take into account interdependencies amongst various objects or IT elements. As a result, the analysis is not optimal from the perspective of an enterprise or organization. Moreover, the assessments in the conventional systems are done manually and are time consuming. As a result, they fail to provide proper assessment in a desired time frame.

### SUMMARY

In one embodiment, method for transforming a portfolio of assets is disclosed. The method includes capturing, via a processor, an existing state of each of a plurality of objects and interdependencies amongst the plurality of objects based on at least one criterion selected for rationalization of the plurality of objects; creating, via the processor, an assessment design to identify a plurality of gaps in the existing state of the plurality of objects; performing analysis, via the processor, on information collected corresponding to each of the plurality of gaps; and employing feedback and machine learning on the analysis performed to generate a transformation roadmap for the portfolio of assets.

In another embodiment, a system for rationalizing a portfolio of assets is disclosed. The system includes at least one processors and a computer-readable medium. The computer-readable medium stores instructions that, when executed by the at least one processor, cause the at least one processor to perform operations that include capturing, via a processor, an existing state of each of a plurality of objects and interdependencies amongst the plurality of objects based on at least one criterion selected for rationalization of the plurality of objects; creating, via the processor, an assessment design to identify a plurality of gaps in the existing state of the plurality of objects; performing analysis, via the processor, on information collected corresponding to each of the plurality of gaps; and employing feedback and machine learning on the analysis performed to generate a rationalization roadmap for the portfolio of assets.

In yet another embodiment, a non-transitory computer-readable storage medium for rationalizing a portfolio of assets is disclosed, which when executed by a computing device, cause the computing device to: capture, via a processor, an existing state of each of a plurality of objects and interdependencies amongst the plurality of objects based on at least one criterion selected for rationalization of the plurality of objects; create, via the processor, an assessment design to identify a plurality of gaps in the existing state of the plurality of objects; perform analysis, via the processor, on information collected corresponding to each of the plurality of gaps; and employ feedback and machine learning on the analysis performed to generate a transformation roadmap for the portfolio of assets.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a block diagram of an exemplary computer system for implementing various embodiments.

FIG. 2 is a block diagram illustrating a system for transformation of a portfolio of assets, in accordance with an embodiment.

FIG. 3 illustrates a flowchart of a method for transforming a portfolio of assets, in accordance with an embodiment.

FIG. 4 illustrates a flowchart of a method for transforming a portfolio of assets, in accordance with another embodiment.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

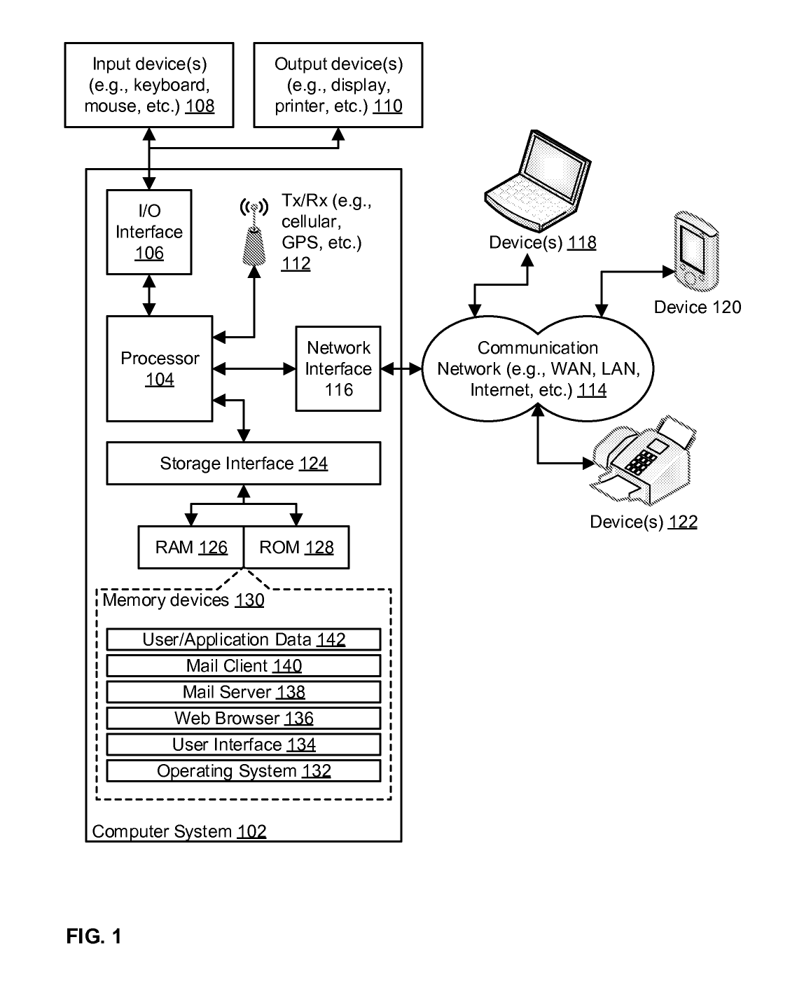

Additional illustrative embodiments are listed below. In one embodiment, a block diagram of an exemplary computer system for implementing various embodiments is disclosed in FIG. 1. Computer system 102 may comprise a central processing unit (“CPU” or “processor”) 104. Processor 104 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. Processor 104 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 104 may be disposed in communication with one or more input/output (I/O) devices via an I/O interface 106. I/O interface 106 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using I/O interface 106, computer system 102 may communicate with one or more I/O devices. For example, an input device 108 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. An output device 110 may be a printer, fax machine, video display (e.g., cathode ray tube (CRT), liquid crystal display (LCD), light-emitting diode (LED), plasma, or the like), audio speaker, etc. In some embodiments, a transceiver 112 may be disposed in connection with processor 104. Transceiver 112 may facilitate various types of wireless transmission or reception. For example, transceiver 112 may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, processor 104 may be disposed in communication with a communication network 114 via a network interface 116. Network interface 116 may communicate with communication network 114. Network interface 116 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. Communication network 114 may include, without limitation, a direct interconnection, local area network (LAN), wide area network (WAN), wireless network (e.g., using Wireless Application Protocol), the Internet, etc. Using network interface 116 and communication network 114, computer system 102 may communicate with devices 118, 120, and 122. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, computer system 102 may itself embody one or more of these devices.

In some embodiments, processor 104 may be disposed in communication with one or more memory devices (e.g., RAM 126, ROM 128, etc.) via a storage interface 124. Storage interface 124 may connect to memory devices 130 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory devices 130 may store a collection of program or database components, including, without limitation, an operating system 132, a user interface application 134, a web browser 136, a mail server 138, a mail client 140, a user/application data 142 (e.g., any data variables or data records discussed in this disclosure), etc. Operating system 132 may facilitate resource management and operation of the computer system 102. Examples of operating system 132 include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 134 may facilitate display, execution, interaction, manipulation, or operation of program components through textual or graphical facilities. For example, user interfaces may provide computer interaction interface elements on a display system operatively connected to computer system 102, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, computer system 102 may implement web browser 136 stored program component. Web browser 136 may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, computer system 102 may implement mail server 138 stored program component. Mail server 138 may be an Internet mail server such as Microsoft Exchange, or the like. The mail server may utilize facilities such as ASP, ActiveX, ANSI C++/C#, Microsoft.NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, computer system 102 may implement mail client 140 stored program component. Mail client 140 may be a mail viewing application, such as Apple Mail, Microsoft Entourage, Microsoft Outlook, Mozilla Thunderbird, etc.

In some embodiments, computer system 102 may store user/application data 142, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

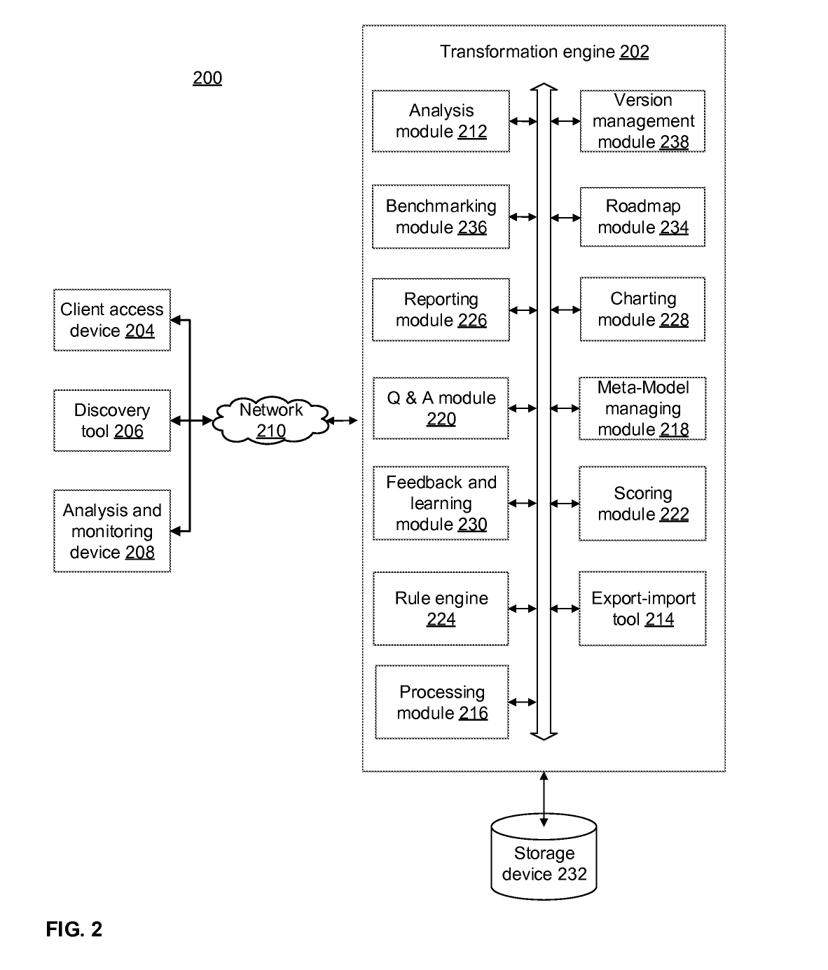

FIG. 2 is a block diagram illustrating a system 200 for transformation of a portfolio of assets, in accordance with an embodiment. The portfolio of assets may be an IT portfolio. System 200 includes a transformation engine 202 that is in communication with a client access device 204, a discovery tool 206, and an analysis and monitoring device 208 through a network 210. Examples of network 210 may include but are not limited to Local Area Network (LAN), Wide Area Network (WAN), or the Internet. Network 210 may be a wired or a wireless network.

Client access device 204 may be an end user computing device and/or a server. Client access device 204 includes information or data associated with a plurality of objects within the portfolio of assets. The plurality of the objects may include, but are not limited to business processes, people, enterprise and business information entity, data and information sources, organization maturity, and various towers of infrastructure. Towers of infrastructure further include but are not limited to data center, databases, servers, end user computing device, service desk, messaging, monitoring tools, backup, and storage. The information or data may include enterprise portfolio data, data from application server instances, and data gathered form web based user surveys. The information or data may be stored in the form of MS Excel sheets or in other similar storage formats.

Therefore, once the plurality of objects to be rationalized have been identified and one or more criteria to rationalize the plurality of objects have also been selected, the information or data associated with the plurality of objects is retrieved by transformation engine 202 via network 210 from client access device 204. This information is then used by an analysis module 212 within transformation engine 202. Thereafter, to capture the existing state of the plurality of objects and the interdependencies amongst the plurality of objects, analysis module 212 communicates with discovery tool 206 which collects information related to discovery of new applications, infrastructure, or data center. To further capture the existing state, analysis module 212 also communicates with an export-import tool 214 that collects data related to the existing state from external systems as well as from within system 200. Export-import tool 214 also feeds in or ingests data in system 200. In an embodiment, the analysis performed by analysis module 212 is enabled by a processing module 216 that processes data gathered from client access device 204, discovery tool 206, and export-import tool 214.

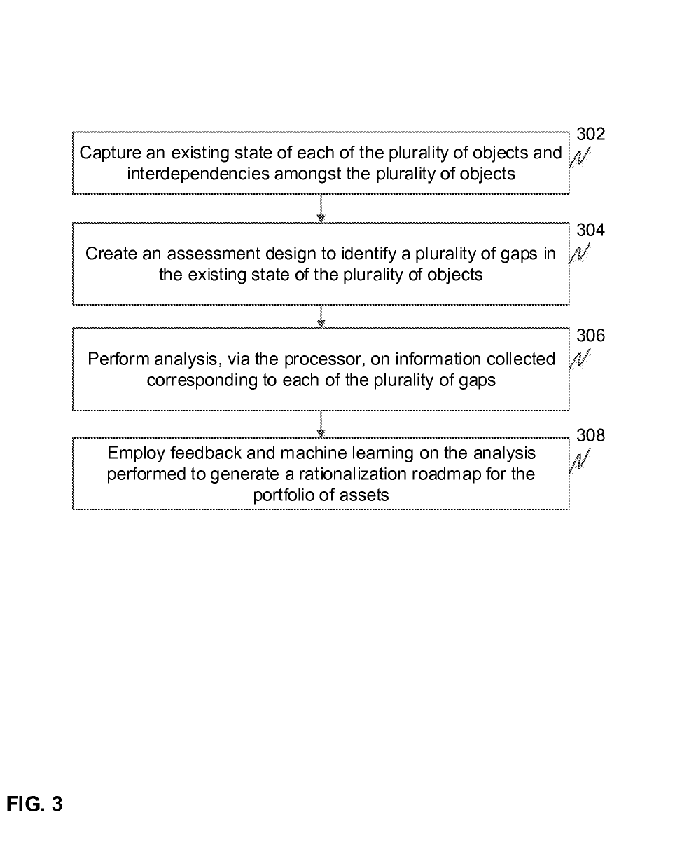

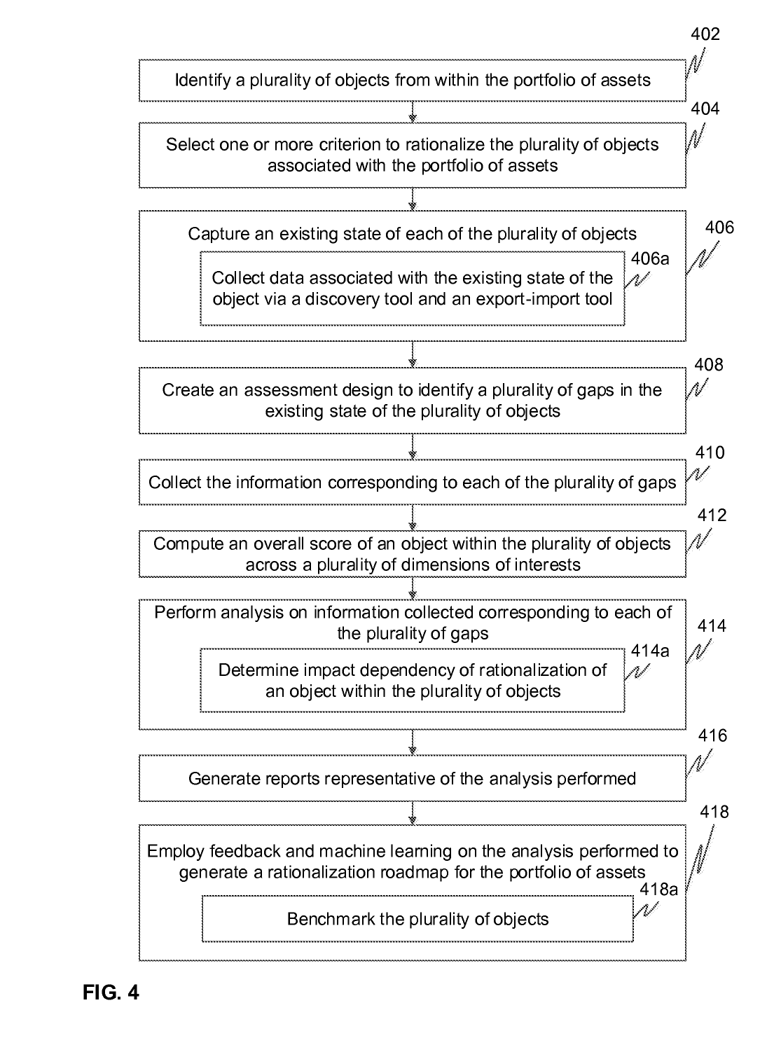

Thereafter, analysis module 212 creates an assessment design to identify a plurality of gaps in the existing state of the plurality of objects. Analysis module 212 may communicate with a meta-model managing module 218 to create the assessment design in the form of meta-models that include clear semantics, which can be easily mapped to the concepts, activities, and tools of standard frameworks in IT industry. Analysis module 212 then communicates with a Question and Answer (Q&A) module 220 to collect the information corresponding to each of the plurality of gaps identified. Q&A module 220 generates a list of questions and answers that may be used by analysis module 212 to perform assessment. In an embodiment, analysis module 212 may also communicate with analysis and monitoring device 208 to automatically capture information corresponding to each of the plurality of gaps identified. Creation of the assessment desing and identificaton of the plurality of gaps is further explained in conjunction with FIGS. 3 and 4.

The information thus collected is used by a scoring module 222 to compute an overall score of an object within the plurality of objects across a plurality of dimensions of interests. In an embodiment, scoring module 222 permits the management and process teams to compute the overall score based on different templates. In an exemplary embodiment, scoring may be based on a scale of 1 to 5 including decimal values. In this scenario, each scoring method may have a unique legend based on the template being completed.

After scoring is completed, analysis module 212 performs analysis on information collected corresponding to each of the plurality of gaps by communicating with processing module 216 and a rule engine 224. Rule engine 224 provides solutions to the plurality of gaps or problems identified. Consequently, rule engine 224 also verifies the solutions so provided. In an embodiment, rule engine 224 may execute one or more business rules in a runtime environment. Performing of the analysis is further explained in detail in conjunction with FIGS. 3 and 4.

The analysis so performed is used by a reporting module 226 to generate reports representative of the analysis. To this end, reporting module 226 communicate with a charting module 228 that generates charts and recommendations using the analysis. These charts and recommendations are included within the reports. This is further explained in conjunction with FIGS. 3 and 4. These reports are then fed into a feedback and learing module 230, which provides feedback on the analysis performed. The feedback thus provided leads to updating of the information used to perform the analysis. This updated information is stored in a storage device 232 and is further used by feedback and learing module 230 to employ automatic machine learning techniques without involving manual intervention. In an embodiment, storage device 232 may be a collection of a plurality of storage devices, which are internal to transformation engine 202. Alternatively, storage device 232 may be located external to transformation engine 202. Storage device 232 may include a data repository that further includes documents, data, web pages, images, and multi-media files that may be used by various modules within transformation engine 202 to enable transformation of the portfolio of assets.

After the feedback and automatic machine learning is complete, a roadmap module 234 generates a transformation roadmap for the portfolio of assets. The transformation roadmap is then used for future assessment and transformation. In an embodiment, roadmap module 234 may communicate with a benchmarking module 236 and a version management module 238 to generate the transformation roadmap.

Benchmarking module 236 may automatically perform benchmarking with respect to information or data that is available internally within system 200 or with respect to externally available information or data. Benchmarking, for example, may be provided on existing IT applications as well as infrastructure within a given organization. In an embodiment, benchmarking module 236 calculates averages and totals and produces weighted and/or unweighted assessments. Further, version management module 238 performs automatic versioning or baselining of states of the plurality of objects. In an embodiment, version management module 238 compares the IT landscape within an organization with the previous IT landscape, which may have been captured an year earlier, in order to determine the change or difference. In another embodiment, version management module 238 checks version of applications being used by an organization, and further provides suggestions on upgrading new version of the respectable applications. The result of these computations performed by benchmarking module 236 and version management module 238 are used by roadmap module 234 to generate a transformation roadmap.

FIG. 3 illustrates a flowchart of a method for transforming a portfolio of assets, in accordance with an embodiment. The portfolio of assets may be an IT portfolio. Alternatively, the portfolio of assets may include but is not limited to intangible assets, for example, people working in a company, products at a retail outlet chain, example, Walmart™ etc, and books in a library or a book shop.

To transform the portfolio of assets, firstly a plurality of objects from within the portfolio of assets is identified for transformation. When the portfolio of assets is an IT portfolio, the plurality of the objects may include but are not limited to business processes, people, enterprise and business information entity, data and information sources, organization maturity, and various towers of infrastructure. Towers of infrastructure further includes, but is not limited to data center, databases, servers, end user computing device, service desk, messaging, monitoring tools, backup, storage.

After the plurality of objects have been identified, one or more criteria for rationalizing the plurality of objects are selected. These one or more criteria are the drivers or the needs for rationalization of the plurality of objects. The one or more criteria may include but are not limited to acquisitions, mergers, dilution of a business unit, reduction of business risk, business efficiency, enhanced performance of application, portfolio, and infrastructure, integration and portability, business and portfolio alignment, architecture maturity, and optimum resource utilization.

At 302, an existing state of each of the plurality of objects is captured along with the interdependencies amongst the plurality of objects. The existing state to be captured is decided based on the one or more criteria selected for rationalization of each of the plurality of objects. By way of an example, acquisition or merger is selected as the criterion for rationalization of the plurality of objects. After an acquisition or merger, there may be a scenario where duplication of applications may occur because of prior use of similar applications by separate entities before the acquisition or merger. Some application might also end up being redundant. Thus, in this case, existing state of an application will include its usability, acceptance, utilization, or familiarity within the company. Additionally, interdependency between the application and resources or other objects utilized by this application, for example, servers, storage, and databases is also captured. As an example of interdependency, discontinuation of an application may lead to freeing up of other objects, for example, server, monitoring tools, databases, and storage. By way of another example, dilution of a business unit is selected as the criteria. In this case, existing state of the objects used by the business unit being diluted is captured. These objects used by the business unit may include data center, databases, servers, end user computing device, and storage. Additionally, interdependencies between these objects are also captured. The existing state is captured by collecting data associated with it using discovery tool 206 and export-import tool 214. Discovery tool 206 and export-import tool 214 have been discussed in conjunction with FIG. 2. Capturing the interdependencies amongst the plurality of objects ensures that assessments performed are more holistic and are not in silo with respect only to individual objects.

After capturing the existing state of the plurality of object and their interdependencies, at 304, an assessment design is automatically created to identify a plurality of gaps in the existing state. The Assessment design may be created in the form of meta-models that include clear semantics, which can be easily mapped to the concepts, activities, and tools of standard frameworks in IT industry. By way of an example, if an application is identified as an object that needs to be rationalized, then a gap in the existing state of the application may include overutilization of other resources, i.e., server, database, storage, by the application. In another scenario, a gap in the existing state of the application may include underutilization or non-familiarity of the application within the company. In yet another scenario, a gap in the existing state of the application may be non-availability of optimum level of resources, for example, server, storage, and end user computing devices.

Thereafter, information corresponding to each of the plurality of gaps is collected. This information is collected based on one or more predefined parameters associated with each of the plurality of gaps. For example, for the identified gap of non-availability of optimum level of resources for an application, the associated parameters may include server, database, monitoring tools, storage, and end user computing devices. Thus, in this example, information is collected for these parameters associated with the identified gap of non-availability of optimum level of resources for an application. In an embodiment, if information cannot be collected for some of the parameters associated with an identified gap, then the number of parameters for which information is to be collected is reduced. With reference to the example given above, if information cannot be collected with respect to end computing devices and monitoring tools, then these parameters are not considered for subsequent analysis.

At 306, analysis is performed on information collected corresponding to each of the plurality of gaps. With reference to the example given above, the parameters associated with the identified gap of non-availability of optimum level of resources for an application may include server, database, monitoring tools, storage, and end user computing devices. Analysis in this case is thus performed on these parameters to determine whether the identified gap can be cured or filled by provisioning or reallocation of resources. For example, during peak access time for the application, considerable part of server and storage resources can be allocated to the application on priority basis. Performing the analysis also includes determining impact dependency of rationalization of an object within the plurality of objects on other objects. Determination of impact dependency is further explained in conjunction with FIG. 4.

Thereafter, reports that are representative of the analysis performed are generated. The reports include application portfolio charts and recommendations associated with rationalization of the portfolio of assets. In one example, an application portfolio chart, generated based on transformation analysis, may indicate four categories: Sustain, Useful, Migrate, and Eliminate. In the Sustain category, applications which should be continued or maintained are indicated. In the Useful category, applications which should be further invested in are indicated. Investment can be made in the applications in the terms of providing more resources, for example, server space, storage, databases etc. In the Migrate category, applications which should be migrated are indicated. In the Eliminate category, applications that should be eliminated and thus discontinued from use are indicated.

At 308, feedback and automatic machine learning are employed on the charts and recommendations in the report representative of the analysis. This generates a transformation roadmap for the portfolio of assets. This transformation roadmap may also include associated cost and benefit analysis of the transformation. A transformation roadmap, may, for example, include analysis on which applications should be tolerated, eliminated, migrated or invested upon. In an exemplary transformation roadmap, cost and benefit analysis with respect to different applications may be indicated.

The transformation roadmap so generated takes into account decision making based on risk, impact or value. Additionally, to generate the transformational roadmap, information that includes historical data, referential data, statistical data, and derived data is also taken into account. Generating the transformation roadmap also includes benchmarking of the plurality of objects with respect to information that is available internally within the company and information that is available external to the company. This is further explained in detail in conjunction with FIG. 4. In an embodiment, generating the transformation roadmap also includes performing versioning or baselining of states of the plurality of objects.

The transformation process thus provides for auto-discovery of applications and integration to other tools for automated collection of data. The assessments performed are objective and data driven. Capturing of benchmark data and machine learning based adjustment of application disposition analysis is also completely automatic.

FIG. 4 illustrates a flowchart of a method for transforming a portfolio of assets, in accordance with another embodiment. To transform the portfolio of assets, at 402, firstly a plurality of objects from within the portfolio of assets is identified for transformation. At 404, one or more criteria for rationalizing the plurality of objects are selected. These one or more criteria are the drivers or the needs for rationalization of the plurality of objects. This has been explained in conjunction with FIG. 3. Thereafter, at 406, an existing state of each of the plurality of objects is captured along with the interdependencies amongst the plurality of objects. The existing state to be captured is decided based on the one or more criteria selected for rationalization of each of the plurality of objects. Capturing the existing state includes, collecting, at 406a, data associated with the existing state of the object. This data is collected by discovery tool 206 and export-import tool 214. This has been explained in conjunction with FIG. 2.

Thereafter, at 408, an assessment design is created to identify a plurality of gaps in the existing state of the plurality of objects. The information corresponding to each of the plurality of gaps are then collected at 410. This has been explained in conjunction with FIG. 3. After collecting the information for gaps, an overall score is computed for an object within the plurality of objects at 412. The computation of the overall score is performed automatically without requiring any human intervention. This is repeated for each of the plurality of objects. The overall score is computed across a plurality of dimensions of interests, such that, the overall score of the object represents usefulness of the object across the plurality of dimensions of interests. At 414, analysis is performed on information collected corresponding to each of the plurality of gaps. Performing the analysis further includes determining, at 414a, impact dependency of rationalization of an object within the plurality of objects on other objects. For example, based on the analysis performed, a conclusion is reached that a particular application is not being used actively by people and thus should be dropped. In this case, the impact of dropping this application would be decommissioning of the server hosting the application. Thus, such impact dependencies of rationalization are also determined.

At 416, reports that are representative of the analysis performed are generated. The reports include charts and recommendations associated with rationalization of the portfolio of assets. At 418, feedback and automatic machine learning are employed on the charts and recommendations in the report representative of the analysis. This generates a transformation roadmap for the portfolio of assets. This has been explained in conjunction with FIG. 3. Generating the transformation roadmap includes, at 418a, benchmarking of the plurality of objects with respect to information that is available internally within the company and information that is available external to the company. Benchmarking, for example, may be provided on existing IT applications as well as infrastructure within a given organization.

Various embodiments of the invention provide methods and system for IT portfolio transformation. The transformation process is web enabled, repository supported, and modular. The transformation process also provides support for auto-discovery of applications and integration to other tools for automated collection of data. The assessments performed are objective and data driven. Moreover, the framework for generating transformation roadmap is highly customizable and generic. It further provides for automated capture of benchmark data and automatic machine learning based adjustment of application disposition analysis. Weights are also adjusted automatically over a period of time by analysis. Additionally, disclosed methods and system help an organization to perform continual transformation, which is useful in case of frequent mergers and acquisitions. The system also does benchmarking and version management in order to make data with respect to continuum of transformation available.

The specification has described methods and systems for IT Portfolio Transformation. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for transforming a portfolio of assets, the method comprising:
capturing, by a portfolio management computing device, an existing state of each of a plurality of objects and interdependencies amongst the plurality of objects based on at least one criterion selected for rationalization of the plurality of objects;
creating, by the portfolio management computing device, an assessment design to identify a plurality of gaps in the existing state of the plurality of objects;
analyzing, by the portfolio management computing device, information collected corresponding to each of the plurality of gaps; and
generating, by the portfolio management computing device, a transformation roadmap for the portfolio of assets based on the analyzed information.

2. The method of claim 1, wherein the portfolio of assets is an IT portfolio.

3. The method of claim 1 further comprising:
identifying, by the portfolio management computing device, the plurality of objects from within the portfolio of assets.

4. The method of claim 1, wherein the plurality of objects comprise one or more of applications, a data center, databases, servers, an end user computing device, a service desk, messaging, monitoring tools, a backup, a storage, business processes, people, information, an enterprise information entity, a business information entity, information sources, or an organization maturity.

5. The method of claim 1 further comprising:
selecting, by the portfolio management computing device, at least one criterion to rationalize the plurality of objects associated with the portfolio of assets.

6. The method of claim 5, wherein the at least one criteria comprises one or more of acquisitions, mergers, dilution of a business unit, reduction of business risk, business efficiency, enhanced performance of application, portfolio, an infrastructure, integration and portability, business and portfolio alignment, architecture maturity, or optimum resource utilization.

7. The method of claim 1, wherein capturing the existing state of an object within the plurality of objects comprises:
collecting, by the portfolio management computing device, data associated with the existing state of the object via a discovery tool and an export-import tool, the discovery tool collecting data comprising discovery of new applications, infrastructure, data center, and the export-import tool collecting data from external and internal systems.

8. The method of claim 1 further comprising:
collecting, by the portfolio management computing device, the information corresponding to each of the plurality of gaps, the information being collected based on at least one predefined parameter associated with each of the plurality of gaps.

9. The method of claim 1 further comprising:
computing, by the portfolio management computing device, an overall score of an object within the plurality of objects across a plurality of dimensions of interests, the overall score of the object being representative of usefulness of the object across the plurality of dimensions of interests.

10. The method of claim 1, wherein the analyzing comprises:
determining, by the portfolio management computing device, impact dependency of rationalization of an object within the plurality of objects on a set of objects within the plurality of objects.

11. The method of claim 1 further comprising:
generating, by the portfolio management computing device, reports representative of the analysis performed via the processor, the reports comprising charts and recommendations associated with rationalization of the portfolio of assets.

12. The method of claim 1, wherein the generating the rationalization roadmap comprises employing feedback and machine learning.

13. A portfolio management computing device, comprising a processor and a memory coupled to the processor which is configured to be capable of executing programmed instructions comprising and stored in the memory to:
capture an existing state of each of a plurality of objects and interdependencies amongst the plurality of objects based on at least one criterion selected for rationalization of the plurality of objects;
create an assessment design to identify a plurality of gaps in the existing state of the plurality of objects;
analyze information collected corresponding to each of the plurality of gaps; and
generate a rationalization roadmap for the portfolio of assets based on the analyzed information.

14. The device of claim 13, wherein the processor coupled to the memory is further configured to be capable of executing at least one additional programmed instruction comprising and stored in the memory to:
identify the plurality of objects from within the portfolio of assets.

15. The device of claim 13, wherein the processor coupled to the memory is further configured to be capable of executing at least one additional programmed instruction comprising and stored in the memory to:
select at least one criterion to rationalize the plurality of objects associated with the portfolio of assets.

16. The device of claim 15, wherein at least one criteria comprises one or more of acquisitions, mergers, a dilution of a business unit, a reduction of business risk, a business efficiency, an enhanced performance of application, a portfolio, an infrastructure, integration and portability, business and portfolio alignment, an architecture maturity, or an optimum resource utilization.

17. The device of claim 13, wherein the processor coupled to the memory is further configured to be capable of executing at least one additional programmed instruction comprising and stored in the memory to:
collect data associated with the existing state of the object via a discovery tool and an export-import tool, the discovery tool collecting data comprising discovery of new applications, infrastructure, data center, and the export-import tool collecting data from external and internal systems.

18. The device of claim 13, wherein the processor coupled to the memory is further configured to be capable of executing at least one additional programmed instruction comprising and stored in the memory to:
collect the information corresponding to each of the plurality of gaps, the information being collected based on at least one predefined parameter associated with each of the plurality of gaps.

19. The device of claim 13, wherein the processor coupled to the memory is further configured to be capable of executing at least one additional programmed instruction comprising and stored in the memory to:
compute an overall score of an object within the plurality of objects across a plurality of dimensions of interests, the overall score of the object being representative of usefulness of the object across the plurality of dimensions of interests.

20. The device of claim 13, wherein the processor coupled to the memory is further configured to be capable of executing at least one additional programmed instruction comprising and stored in the memory to:
determine an impact dependency of rationalization of an object within the plurality of objects on a set of objects within the plurality of objects.

21. A non-transitory computer-readable storage medium having stored thereon instructions for rationalizing a portfolio of assets comprising executable code which when executed by a processor, causes the processor to perform steps comprising:
capturing an existing state of each of a plurality of objects and interdependencies amongst the plurality of objects based on at least one criterion selected for rationalization of the plurality of objects;
creating an assessment design to identify a plurality of gaps in the existing state of the plurality of objects;
analyzing information collected corresponding to each of the plurality of gaps; and
generating a transformation roadmap for the portfolio of assets based on the analyzed information.
